(19) United States
(12) Patent Application Publication
(10) Pub. No.: US 2025/0269780 A1
(43) Pub. Date: Aug. 28, 2025

(54) INSTALLATION SLOT PATHS FOR REMOVABLE FLOOR BLOCKS

(71) Applicant: HYUNDAI TRANSLEAD, San Diego, CA (US)

(72) Inventors: Kaitlyn Paresa, San Diego, CA (US); Loc Bui, San Diego, CA (US)

(21) Appl. No.: 18/652,065

(22) Filed: May 1, 2024

Related U.S. Application Data
(60) Provisional application No. 63/558,257, filed on Feb. 27, 2024.

(51) Int. Cl. B60P 1/43

(52) U.S. Cl. CPC B60P 1/43

(57) ABSTRACT

A platform for a car hauler trailer including: a first frame including a plurality of first insertion paths; a second frame including a plurality of second insertion paths; and a plurality of removable floor blocks, each floor block including a first pin and a second pin, wherein the first pin of each floor block is disposed on a first side and inserts into one of the plurality of first insertion paths in the first frame, wherein the second pin of each floor block is disposed on a second side and inserts into one of the plurality of second insertion paths in the second frame.

### CROSS-REFERENCE TO RELATED APPLICATIONS

This application claims the benefit of priority under 35 U.S.C. § 119(e) of co-pending U.S. Provisional Patent Application No. 63/558, 257, filed Feb. 27, 2024, entitled “Installation Slot Paths for Removable Floor Blocks.” The disclosure of the above-referenced application is incorporated herein by reference.

### BACKGROUND

### Field of the Invention

The present disclosure relates generally to platforms and, more specifically, to installation slot paths for the platforms of removable floor blocks for car hauler trailers.

### Background

A conventional design of a car hauler trailer may include floors for loading the vehicles. The floors may include two separated platforms, one platform each for right tires and another for left tires.

Also, in some trailers, it may be beneficial to be able to “drop” the tires of the loaded vehicle such that the maximum height of the unit (e.g., trailer) and cargo (e.g., vehicle) meets the maximum height restriction. The “drops” were traditionally a permanent fixture of the frame of the car hauler, thus fixing the location where the drops occur. However, to enable the drops to be placed at different locations depending on the size and placement of the loaded vehicle, the platforms with removable floor blocks are configured. For example, to drop a tire, a removable floor block may be removed and adjacent blocks may be flipped upside down to create a right profile to hold the tire in place.

FIG. 1 is a diagram showing a conventional car hauler trailer 100 including the two separated platforms 112, 114. FIG. 1 shows a vehicle 120 including two wheels 122, 124. The wheel 122 is placed on the platform 112, while the wheel 124 is placed on the platform 114. Each of the two platforms 112, 114 may include a plurality of floor blocks, which may be configured as removable floor blocks.

The conventional design of the removable floor blocks includes spring-loaded pins to “lock” the blocks in place. However, springs often break and need to be replaced. Accordingly, a new design of the removable floor blocks are needed.

### SUMMARY

The present disclosure describes a platform for a car hauler trailer.

In one implementation, a platform for a car hauler trailer is disclosed. The platform includes: a first frame including a plurality of first insertion paths; a second frame including a plurality of second insertion paths; and a plurality of removable floor blocks, each floor block including a first pin and a second pin, wherein the first pin of each floor block is disposed on a first side and inserts into one of the plurality of first insertion paths in the first frame, wherein the second pin of each floor block is disposed on a second side and inserts into one of the plurality of second insertion paths in the second frame.

In another implementation, a platform for a car hauler trailer is disclosed. The platform includes: a first frame disposed on a first side of the platform including a plurality of first insertion paths; a second frame disposed on a second side of the platform and including a plurality of second insertion paths; and a plurality of removable floor blocks, each floor block including a first pin and a second pin, wherein the first pin of each floor block inserts into one of the plurality of first insertion paths on the first side to substantially reduce movement of the first pin in a first direction, and wherein the second pin of each floor block inserts into one of the plurality of second insertion paths on the second side to substantially reduce movement of the second pin in a second direction, wherein the first direction and the second direction are selected so that a combination of substantial reduction of movements of the first pin and the second pin keeps each floor block securely within the platform.

In a further implementation, a car hauler trailer is disclosed. The trailer includes: a plurality of platforms, each platform including a first side and a second side, wherein a plurality of first insertion paths is grooved into the first side, and wherein a plurality of second insertion paths is grooved into the second side; a plurality of removable floor blocks, each floor block including a first pin and a second pin, wherein the first pin of each floor block inserts into one of the plurality of first insertion paths in the first side to substantially reduce movement of the first pin in a first direction, wherein the second pin of each floor block inserts into one of the plurality of second insertion paths in the second side to substantially reduce movement of the second pin in a second direction.

Other features and advantages of the present disclosure should be apparent from the present description which illustrates, by way of example, aspects of the present disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a diagram showing a conventional car hauler trailer including the two separated platforms;

FIG. 2 is a diagram of a platform including a plurality of removable floor blocks in accordance with one implementation of the present disclosure;

FIG. 3A is a side perspective view of a platform showing a viewing angle through insertion paths from side A to side B in accordance with one implementation of the present disclosure;

FIG. 3B shows three insertion path views in accordance with one implementation of the present disclosure;

FIG. 4A is a side view of a platform showing two insertion paths views in accordance with one implementation of the present disclosure; and

FIG. 4B is a side view of a platform showing two insertion paths views in accordance with another implementation of the present disclosure.

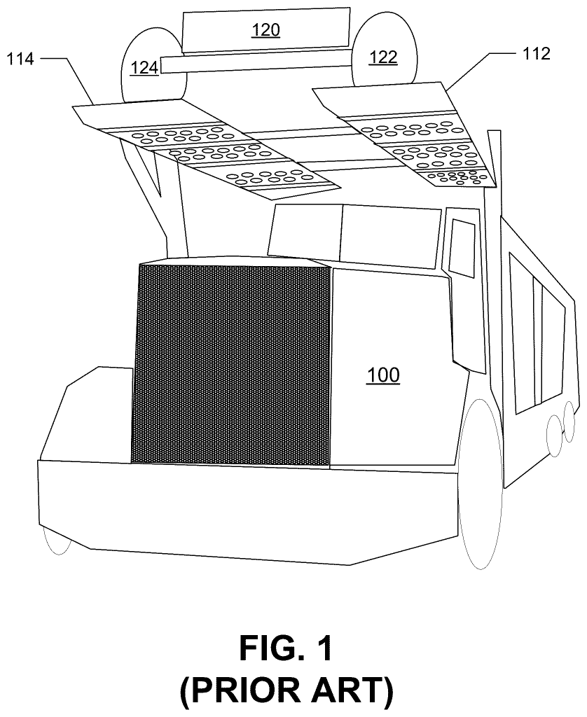

### DETAILED DESCRIPTION

As stated above, the conventional design of the removable floor blocks for a platform includes spring-loaded pins to “lock” the blocks in place. However, springs often break and need to be replaced. To improve the design of the existing removable floor blocks, certain implementations of the present disclosure provide for designing an insertion path for a removable floor block on one side of the platform different from an insertion path on the other side so that the installed position of the removable floor block may be “locked” into place.

Accordingly, after reading this description it will become apparent how to implement the present disclosure in various implementations and applications. Although various implementations of the present disclosure will be described herein, it is understood that these implementations are presented by way of example only, and not limitation. As such, this detailed description of various implementations should not be construed to limit the scope or breadth of the present disclosure.

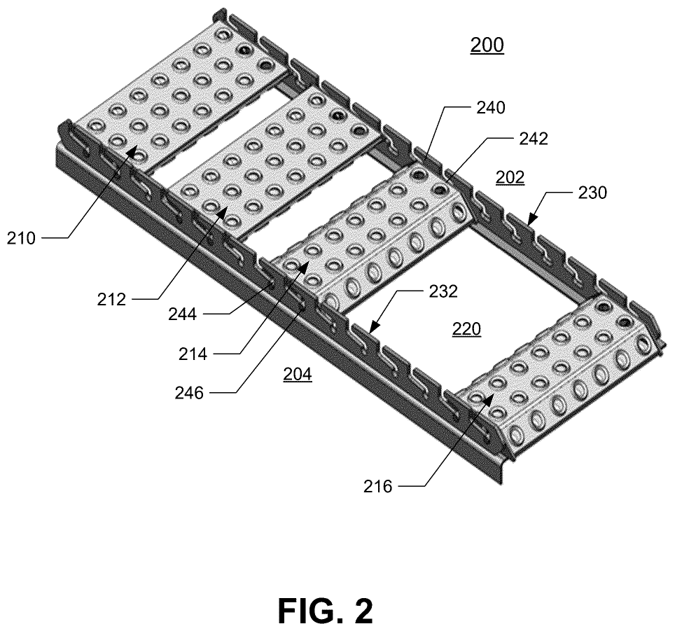

FIG. 2 is a diagram of a platform 200 including a plurality of removable floor blocks 210-216 in accordance with one implementation of the present disclosure. In the illustrated implementation of FIG. 2, the platform 200 includes a first side 202 and a second side 204.

As described above, to place a tire at a drop zone 220, the removable floor blocks 210-216 are configured as shown in FIG. 2. For example, to drop a tire at the drop zone 220, a removable floor block which was at the drop zone 220 is removed and adjacent blocks 214, 216 are flipped upside down to create a profile as shown in FIG. 2 to hold the tire in place at the drop zone 220.

Further, to keep the removable floor blocks 210-216 “locked” into place, the platform 200 is configured with frames 230, 232 on the sides 202, 204. However, a first plurality of insertion paths (for inserting installation pins (e.g., pins 240, 242 for floor block 214) attached to the removable floor blocks 210-216) on the frame 230 of the first side 202 is configured differently from a second plurality of insertion paths (for inserting installation pins (e.g., pins 244, 246 for floor block 214)) on the frame 232 of the second side 204. This variance of the insertion paths on different sides of the platform 200 results in the installed position of a removable floor block to be “locked” into place.

In the illustrated implementation of FIG. 2, the first insertion path on the frame 230 prevents movement of (a pin of) the removable floor block in the vertical direction, while the second insertion path on the frame 232 prevents movement of the removable floor block in the horizontal direction.

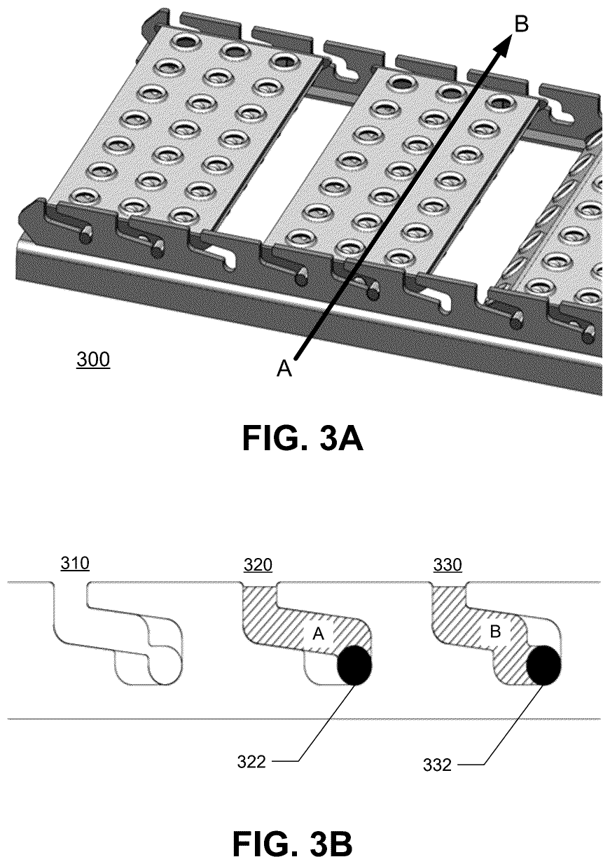

FIG. 3A is a side perspective view of a platform 300 showing a viewing angle through insertion paths from side A to side B in accordance with one implementation of the present disclosure. The platform 300 is substantially similar in design to the platform 200 shown in FIG. 2.

FIG. 3B shows three insertion path views 310, 320, 330 in accordance with one implementation of the present disclosure. The view 310 shows the insertion path on the A side overlaid on top of the insertion path on the B side. The view 320 shows the insertion path on the A side highlighted over the insertion path on the B side. In the view 320, it can be seen that the insertion path on the A side prevents the movement of the floor block in the horizontal direction when the insertion pin 322 is pushed into the end of the insertion path. The view 330 shows the insertion path on the B side highlighted over the insertion path on the A side. In the view 330, it can be seen that the insertion path on the B side prevents the movement of the floor block in the vertical direction when the insertion pin 332 is pushed into the end of the insertion path.

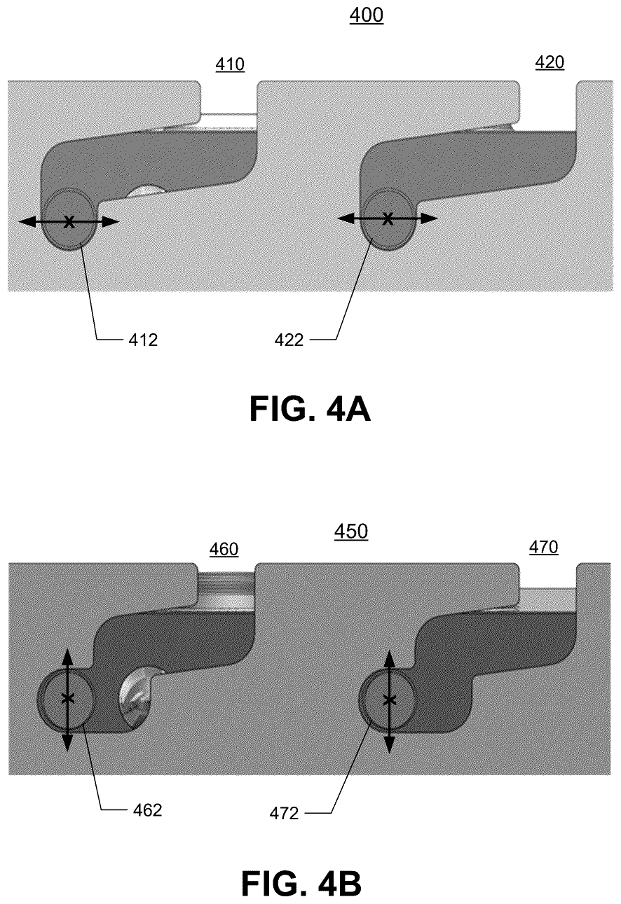

FIG. 4A is a side view of a platform 400 showing two insertion paths views 410, 420 in accordance with one implementation of the present disclosure. The views 410, 420 show the insertion path from the A side (as shown in FIG. 3A). The views 410, 420 also show that the insertion paths on the A side prevent the movement of the floor block in the horizontal direction (as shown in FIG. 4A) when the insertion pins 412, 422 are pushed into the ends of the insertion paths. The term “prevent the movement” as used in the present disclosure refers to absence of movement of the pins outside of the ends of the insertion paths in a specified direction.

FIG. 4B is a side view of a platform 450 showing two insertion paths views 460, 470 in accordance with another implementation of the present disclosure. The views 460, 470 show the insertion path from the B side (as shown in FIG. 3A). The views 460, 470 also show that the insertion paths on the B side prevent the movement of the floor block in the vertical direction (as shown in FIG. 4B) when the insertion pins 462, 472 are pushed into the ends of the insertion paths.

Accordingly, by configuring insertion paths on a first side of a platform to prevent horizontal movement of insertion pins on the first side, and by configuring insertion paths on a second side of the platform to prevent vertical movement of insertion pins on the second side, removable floor blocks inserted into the platform stay locked in place within the platform.

In one particular implementation, a platform for a car hauler trailer is disclosed. The platform includes a first frame, a second frame, and a plurality of removable floor blocks. The first frame includes a plurality of first insertion paths. The second frame includes a plurality of second insertion paths. Each block of the plurality of removable floor blocks includes a first pin and a second pin. The first pin is disposed on a first side and inserts into one of the plurality of first insertion paths in the first frame. The second pin is disposed on a second side and inserts into one of the plurality of second insertion paths in the second frame.

In one implementation, the plurality of first insertion paths is configured to substantially reduce movement of the first pin (e.g., pin 240 in FIG. 2) in a first direction. In one implementation, the plurality of second insertion paths is configured to substantially reduce movement of the second pin (e.g., pin 244 in FIG. 2) in a second direction. In one implementation, the first direction and the second direction are selected so that a combination of substantial reduction of movements of the first pin and the second pin keeps each floor block securely within the platform. In one implementation, the first direction is horizontal and the second direction is vertical. In one implementation, the first direction is substantially perpendicular to the second direction. In one implementation, each floor block further includes: a third pin (e.g., pin 242 in FIG. 2) disposed on the first side and adjacent to the first pin (e.g., pin 240 in FIG. 2), wherein the third pin inserts into another of the plurality of first insertion paths; and a fourth pin (e.g., pin 246 in FIG. 2) disposed on the second side and adjacent to the second pin (e.g., pin 244 in FIG. 2), wherein the fourth pin inserts into another of the plurality of second insertion paths.

In another particular implementation, a platform for a car hauler trailer is disclosed. The platform includes: a first frame disposed on a first side of the platform including a plurality of first insertion paths; a second frame disposed on a second side of the platform and including a plurality of second insertion paths; and a plurality of removable floor blocks, each floor block including a first pin and a second pin, wherein the first pin of each floor block inserts into one of the plurality of first insertion paths on the first side to substantially reduce movement of the first pin in a first direction, and wherein the second pin of each floor block inserts into one of the plurality of second insertion paths on the second side to substantially reduce movement of the second pin in a second direction, wherein the first direction and the second direction are selected so that a combination of substantial reduction of movements of the first pin and the second pin keeps each floor block securely within the platform.

In one implementation, each floor block further includes: a third pin disposed adjacent to the first pin, wherein the third pin inserts into another of the plurality of first insertion paths; and a fourth pin disposed adjacent to the second pin, wherein the fourth pin inserts into another of the plurality of second insertion paths.

In another particular implementation, a car hauler trailer is disclosed. The car hauler trailer includes: a plurality of platforms, each platform including a first side and a second side, wherein a plurality of first insertion paths is grooved into the first side, and wherein a plurality of second insertion paths is grooved into the second side; a plurality of removable floor blocks, each floor block including a first pin and a second pin, wherein the first pin of each floor block inserts into one of the plurality of first insertion paths in the first side to substantially reduce movement of the first pin in a first direction, wherein the second pin of each floor block inserts into one of the plurality of second insertion paths in the second side to substantially reduce movement of the second pin in a second direction.

In one implementation, the first direction and the second direction are selected so that a combination of substantial reduction of movements of the first pin and the second pin keeps each floor block securely within the platform. In one implementation, the first direction is horizontal and the second direction is vertical. In one implementation, the first direction is substantially perpendicular to the second direction. In one implementation, each floor block further includes: a third pin adjacent to the first pin, wherein the third pin inserts into another of the plurality of first insertion paths on the first side; and a fourth pin adjacent to the second pin, wherein the fourth pin inserts into another of the plurality of second insertion paths on the second side.

In the above implementations, the term “substantially reduce movement of the first pin in a first direction” refers to reducing the movement of the first pin in the first direction to less than 5% of the movement in the second direction. In the above implementations, the term “substantially reduce movement of the second pin in a second direction” refers to reducing the movement of the second pin in the second direction to less than 5% of the movement in the first direction. In the above implementations, the term “keeps each floor block securely within the platform” refers to a securement state of a floor block where the floor block does not fall out even when the platform is held upside down.

In the above implementations, the term “horizontal” refers to horizontal or parallel with respect to the surface of the earth. In the above implementations, the term “vertical” refers to vertical (or between 85 to 95 degrees) with respect to “horizontal.” In the above implementations, the term “the first direction is substantially perpendicular to the second direction” refers to the first direction being between 85 to 95 degrees with respect to the second direction.

The disclosed implementations are provided to enable any person skilled in the art to make or use the disclosure. Various modifications to these implementations will be readily apparent to those skilled in the art, and the generic principles described herein can be applied to other implementations without departing from the spirit or scope of the disclosure. For example, although the directions refer to “horizontal”, “vertical”, and “perpendicular”, the relative directions may be less than or greater than perpendicular with respect to each other as long as the combination of directions “keeps each floor block securely within the platform”. Thus, it is to be understood that the description presented herein shows implementations representative of the subject matter which is broadly contemplated by the present disclosure. All features of each implementation are not necessarily required in a particular implementation. Additional variations and implementations are also possible. Accordingly, the present disclosure is not limited only to the specific implementations describe above.

1. A platform for a car hauler trailer, the platform comprising:
a first frame including a plurality of first insertion paths;
a second frame including a plurality of second insertion paths; and
a plurality of removable floor blocks, each floor block including a first pin and a second pin,
wherein the first pin of each floor block is disposed on a first side and inserts into one of the plurality of first insertion paths in the first frame,
wherein the second pin of each floor block is disposed on a second side and inserts into one of the plurality of second insertion paths in the second frame.

2. The platform of claim 1, wherein the plurality of first insertion paths is configured to substantially reduce movement of the first pin in a first direction.

3. The platform of claim 2, wherein the plurality of second insertion paths is configured to substantially reduce movement of the second pin in a second direction.

4. The platform of claim 3, wherein the first direction and the second direction are selected so that a combination of substantial reduction of movements of the first pin and the second pin keeps each floor block securely within the platform.

5. The platform of claim 3, wherein the first direction is horizontal and the second direction is vertical.

6. The platform of claim 3, wherein the first direction is substantially perpendicular to the second direction.

7. The platform of claim 1, wherein each floor block further comprises:
a third pin disposed on the first side and adjacent to the first pin,
wherein the third pin inserts into another of the plurality of first insertion paths; and
a fourth pin disposed on the second side and adjacent to the second pin,
wherein the fourth pin inserts into another of the plurality of second insertion paths.

8. A platform for a car hauler trailer, the platform comprising:
a first frame disposed on a first side of the platform including a plurality of first insertion paths;
a second frame disposed on a second side of the platform and including a plurality of second insertion paths; and
a plurality of removable floor blocks, each floor block including a first pin and a second pin,
wherein the first pin of each floor block inserts into one of the plurality of first insertion paths on the first side to substantially reduce movement of the first pin in a first direction, and
wherein the second pin of each floor block inserts into one of the plurality of second insertion paths on the second side to substantially reduce movement of the second pin in a second direction,
wherein the first direction and the second direction are selected so that a combination of substantial reduction of movements of the first pin and the second pin keeps each floor block securely within the platform.

9. The platform of claim 8, wherein each floor block further comprises:
a third pin disposed adjacent to the first pin,
wherein the third pin inserts into another of the plurality of first insertion paths; and
a fourth pin disposed adjacent to the second pin,
wherein the fourth pin inserts into another of the plurality of second insertion paths.

10. A car hauler trailer comprising:
a plurality of platforms, each platform including a first side and a second side,
wherein a plurality of first insertion paths is grooved into the first side, and
wherein a plurality of second insertion paths is grooved into the second side;
a plurality of removable floor blocks, each floor block including a first pin and a second pin,
wherein the first pin of each floor block inserts into one of the plurality of first insertion paths in the first side to substantially reduce movement of the first pin in a first direction,
wherein the second pin of each floor block inserts into one of the plurality of second insertion paths in the second side to substantially reduce movement of the second pin in a second direction.

11. The trailer of claim 10, wherein the first direction and the second direction are selected so that a combination of substantial reduction of movements of the first pin and the second pin keeps each floor block securely within the platform.

12. The trailer of claim 10, wherein the first direction is horizontal and the second direction is vertical.

13. The trailer of claim 10, wherein the first direction is substantially perpendicular to the second direction.

14. The trailer of claim 10, wherein each floor block further comprises:
a third pin adjacent to the first pin,
wherein the third pin inserts into another of the plurality of first insertion paths on the first side; and
a fourth pin adjacent to the second pin,
wherein the fourth pin inserts into another of the plurality of second insertion paths on the second side.
